(19) United States
(12) Patent Application Publication
(10) Pub. No.: US 2025/0252370 A1
(43) Pub. Date: Aug. 7, 2025

(54) BEHAVIOR ANALYSIS SYSTEM AND BEHAVIOR ANALYSIS METHOD

(71) Applicant: Hitachi, Ltd., Tokyo (JP)

(72) Inventors: Sanato OHTOSHI, Tokyo (JP); Ryota KAWAMATA, Tokyo (JP); Naohito IKEDA, Tokyo (JP)

(21) Appl. No.: 18/928,292

(22) Filed: Oct. 28, 2024

(30) Foreign Application Priority Data
Feb. 2, 2024 (JP) 2024-014838

(51) Int. Cl. G06Q 10/0631

(52) U.S. Cl. CPC G06Q 10/063114

(57) ABSTRACT

A behavior analysis system including: an input unit configured to receive an input of measurement data collected from the worker and the object; a human movement estimating unit configured to estimate a movement of the worker; an object position/orientation estimating unit configured to estimate a position and an orientation of the object; an object model plotting unit configured to extract an object model having a same shape as the object having the position and the orientation estimated, from the object model database, and plot the extracted object model in a virtual space; a body model plotting unit configured to extract a body model of the worker having the movement estimated, from a body model database, and plot the extracted body model in the virtual space; an interrelationship analyzing unit configured to analyze an interrelationship between the body model and the object model; and an interrelationship output unit.

### CROSS-REFERENCE TO RELATED APPLICATION

The present application claims priority from Japanese patent application JP 2024-14838 filed on Feb. 2, 2024, the content of which is hereby incorporated by reference into this application.

### BACKGROUND OF THE INVENTION

### 1. Field of the Invention

The present invention relates to a behavior analysis system.

### 2. Description of the Related Art

Behavior analysis methods for three-dimensionally reconstructing the actions involved in a work by collecting measurements of the movements of objects, and making in- detail evaluations of the efficiency of the actions are currently being used in various fields, such as the field of device designing.

The following conventional technology is known as a background art of this technical field. JP 2020-187778 A discloses an information processing device that is communicable with a display device configured to display a mixed reality image in which three-dimensional models are superimposed over a real image on the basis of the positions and the orientations of the three-dimensional models in a space, and that stores therein the positions and the orientations of the three-dimensional models, the information processing device including: a storage unit configured to store therein, among the three-dimensional models, a first model that is a target of an action of a work and a second model representing a tool used on the first model during the work, in a manner associated with each other; a real object detection unit configured to detect a real object; a determination unit configured to determine whether a position of the real object detected by the real object detection unit and a position of the first model are within a predetermined distance; an identifying unit configured to identify the second model corresponding to the first model when the determination unit determines that the position of the real object and the position of the first model are within the predetermined distance; a decision unit configured to decide a position and an orientation of the second model identified by the identifying unit in the space, with reference to the position and the orientation of the real object; a movement detection unit configured to detect that the real object detected by the detection unit has made a predetermined movement; a contact determination unit configured to determine, when the movement detection unit detects that the real object has made the predetermined movement, whether the real object making the predetermined movement or the second model having the position and the orientation determined by the determination unit, with reference to the position and the orientation of the real object, has come into contact with another three-dimensional model; and a display control unit configured to control, when the contact determination unit determines that the second model has come into contact with the other three-dimensional model, to display information indicating the contact has been made, on a display screen of the display device.

### SUMMARY OF THE INVENTION

In the invention disclosed in JP 2020-187778 A, there is room for improvement in the three-dimensional models for analyzing the behavior of a worker with respect to an object.

An object of the present invention is to make an in-detail analysis of a behavior taken by a worker on a target object.

A representative example of the invention disclosed in the present application is as follows. That is, a behavior analysis system that analyzes an interrelationship between a worker and an object, the behavior analysis system including: a computer including a processor device configured to execute predetermined processing and a storage device connected to the processor device, in which the processor device includes: an input unit configured to receive an input of measurement data collected from the worker and the object; a human movement estimating unit configured to estimate a movement of the worker based on the measurement data; an object position/orientation estimating unit configured to estimate a position and an orientation of the object based on the measurement data; an object model plotting unit configured to extract an object model having a same shape as the object having the position and the orientation estimated, from the object model database, and to plot the extracted object model in a virtual space at the position and the orientation estimated by the object position/orientation estimating unit; a body model plotting unit configured to extract a body model of the worker having the movement estimated, from a body model database, and to plot the extracted body model in the virtual space in accordance with the movement estimated by the human movement estimating unit; an interrelationship analyzing unit configured to analyze an interrelationship between the body model and the object model based on a position of the body model and the position and the orientation of the object model plotted in the virtual space; and an interrelationship output unit configured to output the interrelationship analyzed by the interrelationship analyzing unit.

According to one aspect of the present invention, it is possible to provide interrelationship data for making an in-detail analysis of a behavior taken by a worker on a target object. Problems, configurations, and advantageous effects other than those explained above will become clear from the following description of the embodiment.

### BRIEF DESCRIPTION OF THE DRAWINGS

FIG. 1 is a functional block diagram illustrating functions of a processor device according to a first embodiment;

FIG. 2 is a diagram illustrating an example of body pose data according to the first embodiment;

FIG. 3 is a diagram illustrating an example of object position/orientation data according to the first embodiment.

FIG. 4 is a hardware configuration diagram of the processor device according to the first embodiment;

FIG. 5 is a diagram illustrating an example of a three-dimensional body model and a three-dimensional object model plotted in a virtual space according to the first embodiment;

FIG. 6 is a flowchart illustrating processing performed by an interrelationship analyzing unit according to the first embodiment;

FIG. 7 is a diagram illustrating an example of interrelationship data according to the first embodiment;

FIG. 8 is a diagram illustrating an example of simultaneous recognition probability data between three-dimensional object models according to a second embodiment; and

FIG. 9 is a functional block diagram illustrating functions of a processor device according to a fourth embodiment.

### DESCRIPTION OF THE PREFERRED EMBODIMENTS

### First Embodiment

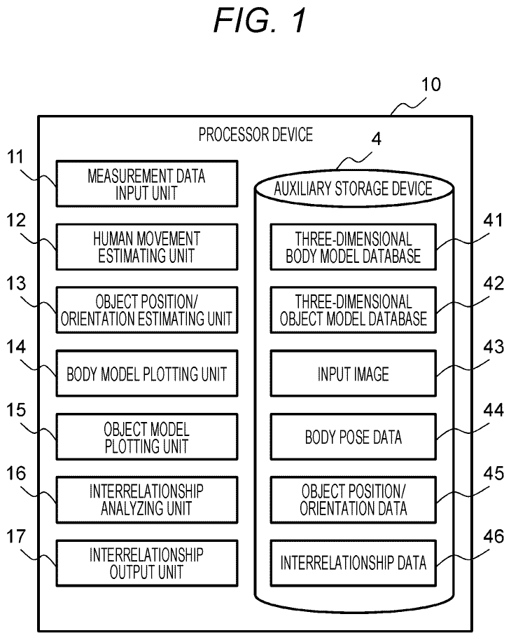

A behavior analysis system according to a first embodiment will now be described with reference to FIGS. 1 to 6.

FIG. 1 is a functional block diagram illustrating functions of a processor device 10 included in a behavior analysis system according to the first embodiment. Note that, in FIG. 1, data stored in an auxiliary storage device 4 included in the processor device 10 is also illustrated.

The processor device 10 according to this embodiment reads measurement data related to a plurality of objects, analyzes a relationship therebetween, and outputs a result. The processor device 10 includes, as functional blocks thereof, a measurement data input unit 11, a human movement estimating unit 12, an object position/orientation estimating unit 13, a body model plotting unit 14, an object model plotting unit 15, an interrelationship analyzing unit 16, and an interrelationship output unit 17.

The auxiliary storage device 4 stores therein a three-dimensional body model database 41 and a three-dimensional object model database 42. The three-dimensional body model database 41 stores therein a three-dimensional mesh model the orientation of which is operable using input values corresponding to a plurality of respective joint points. The three-dimensional object model database 42 stores therein a three-dimensional mesh model representing an object to be recognized. An example of the three-dimensional mesh model is a three-dimensional computer-aided-design (CAD) data of a target device component, or a mesh model created by three-dimensionally measuring an object to be recognized, in advance. An input image 43, body pose data 44, and object position/orientation data 45 are stored by one of the measurement data input unit 11, the human movement estimating unit 12, and the object position/orientation estimating unit 13, and interrelationship data 46 is generated and stored by the interrelationship analyzing unit 16.

The measurement data input unit 11 reads measurement data that includes information for identifying an orientation of a person or an orientation of an object, identifies the type of data on the basis of the data format, and inputs the identified data to an appropriate functional block. Specifically, when the measurement data input unit 11 receives an input of image data captured by a camera, for example, the data is input to the human movement estimating unit 12 and the object position/orientation estimating unit 13. When the measurement data input unit 11 receives position data measured by an inertial sensor, for example, the data is input to the body model plotting unit 14 or the object model plotting unit 15, depending on which model the position data corresponds to. The image data input to the human movement estimating unit 12 and the object position/orientation estimating unit 13 may be an RGB image including color information, or a depth image including distance information.

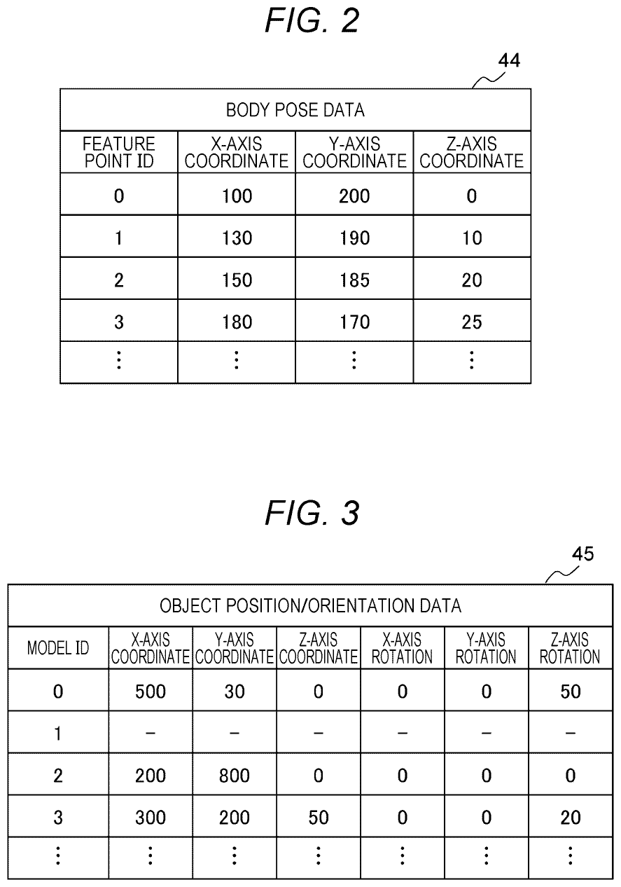

The human movement estimating unit 12 detects a body from the input image data, estimates a movement represented by time-series positions of feature points that are representative of the body, such as joint points of the detected body, in a virtual three-dimensional space, and stores the movement in the body pose data 44. The three-dimensional coordinates of the feature points illustrated in FIG. 2 are then input to the body model plotting unit 14, as body pose data. The body pose data input to the body model plotting unit 14 may not be the data of the entire body, but data of a part of the body such as a hand or a foot. Specifically, when an image of a camera mounted on a head mounted display (HMD) worn by a worker is used, because mainly estimated is the orientation data of an arm, it is preferable to input orientation data of an arm of the worker.

When a piece of image data is input to the human movement estimating unit 12, an orientation of a body is inferred from the image using a trained model, having been trained by machine learning. Generally, as types of processing sequence, there are top-down processing and bottom-up processing. The top-down processing is a method for extracting regions including persons from the image, and inferring the orientation of each of such persons included in each of the regions. With this processing, orientation information can be inferred highly accurately, even from an image including a plurality of persons. By contrast, the bottom-up processing is a method of inferring the positions of every feature point of a body from the entire image, and then inferring an orientation connecting the feature points. While this processing accrues less calculation load, compared with that in the top-down processing, the accuracy of the inference tends to be lower when the image includes a plurality of persons. These types of processing sequence are changed depending on the application. Specifically, in a non-real-time application for evaluating the quality of work after the completion of the work and capturing an image of a plurality of workers with a camera from a distance, the top-down processing is used. In a real-time application in which an analysis result of a work is to be visually presented to the worker in real time and only the body of the worker is captured by the camera, the bottom-up processing is used.

When the input data include a depth image, the human movement estimating unit 12 converts the two-dimensional orientation into a three-dimensional orientation, by making an inference of the two-dimensional orientation from the RGB image and then acquiring the distance information of corresponding pixels from the depth image. When the input data only includes an RGB image, the three-dimensional orientation is inferred using a machine learning model having been trained with conversions of two-dimensional orientations into three-dimensional orientations.

The object position/orientation estimating unit 13 extracts a three-dimensional object model having a shape similar to that of each object included in the input image data, from those in the three-dimensional object model database 42, and calculates position/orientation data of the object, using the extracted three-dimensional object model. As illustrated in FIG. 3, the object position/orientation data is represented by an X-axis coordinate, a Y-axis coordinate, a Z-axis coordinate, an X-axis rotation, a Y-axis rotation, and a Z-axis rotation that are associated with a model ID. A model ID and a three-dimensional object model are associated with each other.

The object position/orientation estimating unit 13 infers the position/orientation data of an object from an RGB image and a depth image generated using the object model stored in the three-dimensional object model database 42, with the machine learning model having been trained in a manner suitable for the actual input data format, using one or both of RGB images and depth images. Specifically, a plurality of feature points the distance therebetween is the longest among those on the surface of the object model is extracted; three-dimensional coordinates of each of such feature points are obtained from the image data; and the position/orientation of the object is calculated in such a manner that average distance errors with respect to the respective feature points of the object model are minimized. By including, as the training data for training the machine learning model, an edited image composed of image data obtained by capturing images of an object model from various different distances and directions, and an image of the actual work site combined thereto as the background, the accuracy of the object position/orientation estimations can be improved.

By configuring the human movement estimating unit 12 and the object position/orientation estimating unit 13 to receive RGB image data as input image data but not distance information, a general camera can be used as a device for collecting the measurements, so that it becomes possible to provide an inexpensive and lightweight system. By contrast, in order to add the depth image, stereo vision using a plurality of cameras or a time-of-flight ranging function becomes necessary; however, the accuracy of the body and object orientation estimations can be improved by the use of a depth image. Therefore, the human movement estimating unit 12 and the object position/orientation estimating unit 13 preferably include an orientation estimation model trained with RGB images as well as orientation estimation model trained with depth images, so as to be able to cope with inputs of images in either one of these formats.

The body model plotting unit 14 extracts a three-dimensional body model from the three-dimensional body model database 41, and plots each sub-model included in the three-dimensional body model to the virtual three-dimensional space, in accordance with the coordinates of the feature points stored in the body pose data 44. Note that the body model plotting unit 14 hides a sub-model including a feature point not having the coordinates thereof stored in the body pose data 44, for a reason that such a feature point is not included in the input image 43, and plots only the orientations of the other parts.

The object model plotting unit 15 reads the object position/orientation data 45, extracts the three-dimensional object models having the model IDs corresponding to the position/orientation data from the three-dimensional object model database 42, and plots the three-dimensional models of the respective objects to the virtual three-dimensional space, in accordance with the orientation corresponding to the model ID. When an input data is a continuous data series such as a movie, the object model plotting unit 15 expresses the movement of an object by plotting the object models correspondingly to the respective frame images, while preventing the same object from being plotted in plurality at the same time. However, when a plurality of objects having the same shape are included in the same frame image, an object model corresponding to the same model ID is plotted in plurality at the same time.

The interrelationship analyzing unit 16 analyzes a relationship between a three-dimensional body model and a three-dimensional object model on the basis of the position of the body model plotted in the virtual three-dimensional space and the positions/orientation of the object model plotted in the virtual three-dimensional space. Specifically, the interrelationship analyzing unit 16 computes the presence or absence of collision between the three-dimensional body model and the three-dimensional object model, and calculates the presence or absence of contact among the objects corresponding to the respective pieces of input data, and if there is any, the point of contact. The interrelationship analyzing unit 16 also analyzes dynamic relationships between the objects corresponding to the respective pieces of input data, by matching the input data against the frame numbers and time stamps included in the video.

The interrelationship output unit 17 outputs, as a result of the analysis of the interrelationship analyzing unit 16, the body pose data 44, the object position/orientation data 45, and the interrelationship data, to the input/output device 5 or the communication device 6.

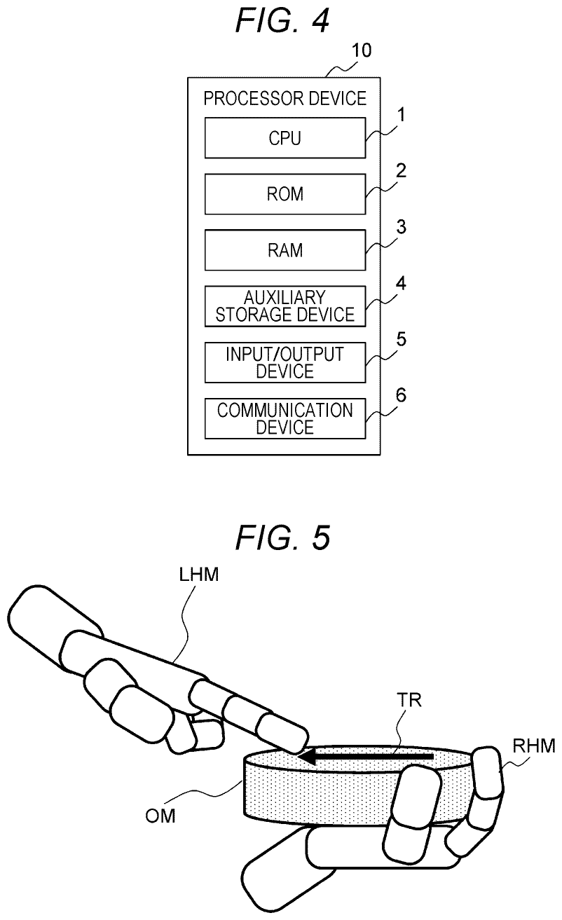

FIG. 4 is a schematic illustrating a hardware configuration of the processor device 10.

The processor device 10 includes a CPU 1 that is a central processing unit, a ROM 2 that is a storage device from which data is read, a RAM 3 that is a storage device from and to which data can be read and written, the auxiliary storage device 4 that is a nonvolatile storage device, an input/output device 5 that is a user interface, and a communication device 6 that controls communication with other devices. The CPU 1 implements, by loading a program stored in the ROM 2 onto the RAM 3 and executing the program, the measurement data input unit 11, the human movement estimating unit 12, the object position/orientation estimating unit 13, the body model plotting unit 14, the object model plotting unit 15, and the interrelationship analyzing unit 16.

The ROM 2 stores therein a program that does not change (e.g., BIOS), for example. The RAM 3 is a high-speed volatile storage element, such as a dynamic random access memory (DRAM), and temporarily stores therein a program executed by the processor device 10 and data used in the execution of the program.

The auxiliary storage device 4 is, for example, a large-capacity nonvolatile storage device such as a magnetic storage device (HDD) or a flash memory (SSD). The auxiliary storage device 4 also stores therein data used when the CPU 1 executes a program (such as the three-dimensional body model database 41, the three-dimensional object model database 42, the input image 43, the body pose data 44, the object position/orientation data 45, and the interrelationship data 46) and the program executed by the CPU 1.

The input/output device 5 is a keyboard or a mouse, for example, and includes an interface that receives an input from an operator, and an interface such as a display device or a wearable device (e.g., VR goggles) that outputs an image that is the result of executing a program in a form visually recognizable by the user. Note that the input/output device 5 may be provided by a terminal (not illustrated) connected to the processor device 10 via a network. In such a case, the processor device 10 may have a function of a web server, and the terminal may access the processor device 10 using a predetermined protocol (e.g., http).

The communication device 6 is a network interface device that controls communication with other devices, in accordance with a predetermined protocol.

The processor device 10 may also be implemented as a field programmable gate array (FPGA) that is a rewritable logic circuit, or an application-specific integrated circuit (ASIC), instead of the combination of the CPU 1, the ROM 2, and the RAM 3. The processor device 10 may also be implemented by a different combination of the elements, such as a combination of the CPU 1, the ROM 2, the RAM 3, and the FPGA, instead of the combination of the CPU 1, the ROM 2, and the RAM 3.

The program executed by the CPU 1 is provided to the processor device 10 via a removable medium (e.g., a CD-ROM or a flash memory) or over a network, and is stored in the nonvolatile auxiliary storage device 4 that is a non-transitory storage medium. Therefore, the processor device 10 may have an interface for reading data from a removable medium.

The processor device 10 is a computer system physically built on one computer or a plurality of logically or physically configured computers, and may also operate on a virtual computer built on a plurality of physical computer resources. For example, each of the functional units may operate on an independent physical or logical computers, or a plurality of functional units may be combined and operate on one physical or logical computer.

FIG. 5 is a diagram illustrating an example of the three-dimensional body models and the three-dimensional object model configured in the virtual space by the body model plotting unit 14 and the object model plotting unit 15, respectively, and illustrates an example in which a right hand model RHM is holding an object model OM, and a left hand model LHM is touching the object model OM.

The interrelationship analyzing unit 16 converts the coordinates of feature points of the right hand model RHM and the left hand model LHM into those in a coordinate system of orientations of the object models OM. If each of the body models is in contact with the object model OM and the feature point coordinates belonging to the body model do not move in the object model orientation coordinate system, it is determined that the body model is holding the object model OM. If the feature point coordinates belonging to the body model move in the object model orientation coordinate system, trajectory information TR of the body model is recorded.

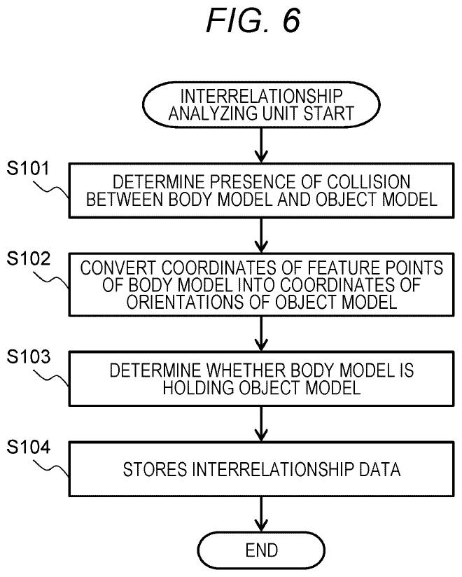

FIG. 6 is a flowchart illustrating processing performed by the interrelationship analyzing unit 16.

By the time at which the interrelationship analyzing unit 16 starts the processing, the body model plotting unit 14 and the object model plotting unit 15 have completed plotting the three-dimensional body model and the three-dimensional object model in the virtual space. To begin with, in step S101, the interrelationship analyzing unit 16 determines the presence of collision between the body model and the object model plotted in the virtual space, and calculates the presence or absence of contact, and the point of contact, if there is any. In step S102, the interrelationship analyzing unit 16 converts the feature point coordinates of the body model into the orientation coordinates of the object model. In step S103, the interrelationship analyzing unit 16 determines whether the body model is holding the object model. As a method of determining whether the body model is holding an object model, the method described with reference to FIG. 5 may be used. In step S104, the interrelationship analyzing unit 16 stores the result of determining the presence of contact, the contact point, and the result of determining whether the body model is holding the object model, as the interrelationship data 46, and ends the processing illustrated in FIG. 6.

The analysis method executed by the interrelationship analyzing unit 16 in step S103 may be set in advance depending on the type of work. For example, for transportation work, the interrelationship data 46 may be calculated using a correlation coefficient between time-series data of the coordinates of feature point of joints or the like in the body model and time-series data of the coordinates of feature points of the object model. Furthermore, the interrelationship analyzing unit 16 may use an analysis method to calculate the quality of transportation work, by determining that a worker is holding an object with a part of the body model, such as a hand, including feature points, at the time at which the correlation coefficient of the coordinates of the feature point is equal to or more than a predetermined threshold, and using a result of comparison between the acceleration of the body model and the acceleration of the object model being held by the body model, and of a determination of contact between the body model and the object model, as the interrelationship data 46. As another example, for screw tightening work, the interrelationship analyzing unit 16 may use an analysis method for determining the condition of how the screw is tightened, e.g., temporarily fixed or tightened additionally, by calculating the interrelationship data 46 on the basis of the amount of rotation or the angular velocity by which the feature points of a hand of the body model have moved about the center axis of a screw or a screw hole included in an object model. As another example, for assembling work, the interrelationship analyzing unit 16 may use an analysis method for determining whether parts are assembled in a correct order, by analyzing, when an object model and a hand of a body model come into contact with each other, whether the object model is in the condition prior to the work is done, for example, whether another object model has already been assembled thereto, from the shape, and calculating the interrelationship data 46. As another example, for wiping work, the interrelationship analyzing unit 16 may use an analysis method for visualizing the condition of a surface having been wiped and quantifying the progress of the work, by calculating the interrelationship data 46 using a surface with which the hand part of the body model has come into contact, among the surfaces to be wiped on the object model. As another example, for inspection and checking work, the interrelationship analyzing unit 16 may use an analysis method or the like for calculating the interrelationship data 46 on the basis of the hand of the body model coming into contact with a part of the object model, the part having been registered as a part to be checked tactilely, or on the basis of the fact that a half line including a feature point forming an index finger is directed toward a part having been registered as a part to be visually checked, with an index finger of the body model in a shape pointing to the object.

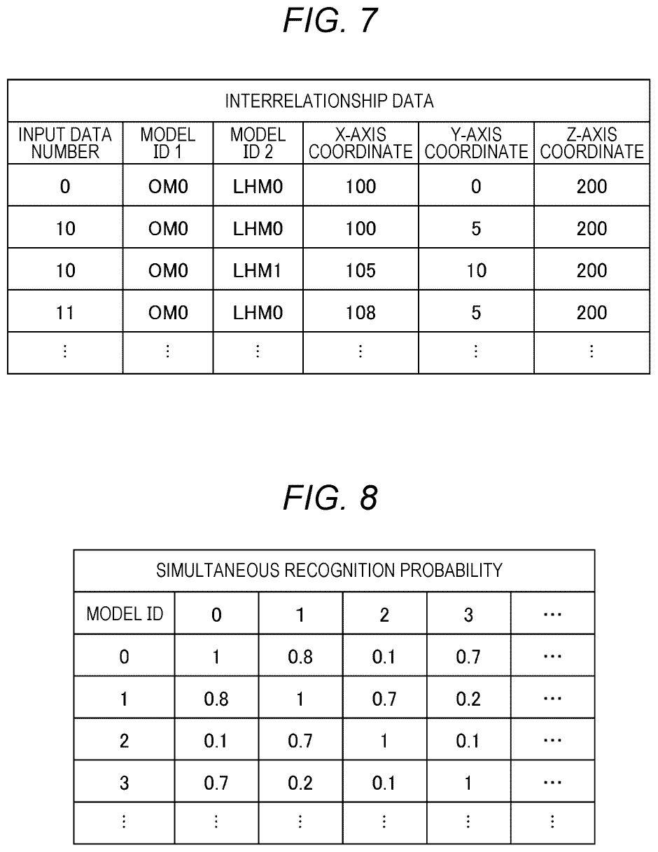

The interrelationship output unit 17 outputs the interrelationship data 46 stored in step S103 to the input/output device 5 or the communication device 6, together with the body pose data 44 and the object position/orientation data 45. FIG. 7 is a diagram illustrating an example of the interrelationship data 46 when the data input from the measurement data input unit 11 represents a continuous data sequence such as a video, the interrelationship data 46 being output when the preset analysis method is the method for determining the contact, illustrated in FIG. 5. The interrelationship data 46 includes an input data number given to each piece of input data determined to be in contact, a contacted object model ID (OM0) paired with a body model (LHM0, LHM1), and the coordinates indicating the three-dimensional position of the contact. The coordinates of the three-dimensional position are all recorded with respect to the origin of either the virtual space coordinate system or the object model orientation coordinate system, but the coordinates of the three-dimensional position in one of the coordinate system can be converted to the other, using the object position/orientation data 45. By combining the output data output from the interrelationship output unit 17 and the three-dimensional mesh model stored in the three-dimensional object model database 42, for example, the contact position can be visualized by rewriting texture information in the three-dimensional mesh model with the contact position coordinate information.

According to the first embodiment described above, the following actions and effects can be achieved.

(1) In the image data input to the measurement data input unit 11, even if the object that is the target of the work is partially hidden by the body, it is possible to provide a virtual space environment allowing the work to be visually checked with the shape of the object in the blind spot complemented, by reconstructing the object that is the target of the work using the three-dimensional object model stored in the three-dimensional object model database 42.
(2) It is possible to provide the interrelationship data 46 for allowing in-detail analysis of a behavior, such as touching and holding, performed by a worker with respect to the object that is the target of the work by determining the presence of collision between the three-dimensional object model and the three-dimensional body model, and calculating the trajectory of the three-dimensional body model in the coordinate system of the orientation of the object model.
(3) For an analysis of behaviors of a worker, it is possible to evaluate a work done with respect to an object that is the target of the work, even for a work that is difficult to determine merely with the movement of a person. For example, it is possible to evaluate the safety of work by detecting an acceleration applied to each part of an object while the object is being transported, or events such as collision between objects.

### Second Embodiment

A second embodiment of a behavior analysis system will now be described with reference to FIG. 7. In the following description, the same components as those in the first embodiment are given the same reference numerals, and differences will be mainly explained. The points not specifically described hereunder are the same as those in the first embodiment. This embodiment is different from the first embodiment in that a three-dimensional object model having the same shape as an object the position and the orientation of which are to be estimated is extracted using a simultaneous recognition probability between three-dimensional object models.

FIG. 7 is a table indicating an example of simultaneous recognition probability data for the three-dimensional object models, in the second embodiment.

The simultaneous recognition probability data records a probability, for each pair of model IDs registered in the three-dimensional object model database 42, at which such objects are recognized simultaneously in a piece of image data input to the object position/orientation estimating unit 13.

From history information of the past estimations made by the object position/orientation estimating unit 13, the number of times each pair of model IDs is recognized simultaneously in a single piece of input image data is counted, and a simultaneous recognition probability is calculated therefrom. For example, when three-dimensional object models corresponding to the model ID0 and the model ID1 are recognized simultaneously in 80 pieces of image data out of 100 pieces, the simultaneous recognition probability is calculated as 0.8.

When it is difficult to ensure a sufficient number of pieces of image data in advance, the three-dimensional object models registered in the three-dimensional object model database 42 are plotted in typical positional relationships in the virtual space, and the distance between each pair of objects corresponding to a pair of model IDs is calculated. The simultaneous recognition probability data is then calculated by applying normalization in such a manner that the simultaneous recognition probability of a pair of model IDs corresponding to the nearest objects becomes 1, and the simultaneous recognition probability of the pair of model IDs corresponding to the farthest objects becomes 0. One example of the typical positional relationship is an arrangement of components in an assembly of device components.

According to the second embodiment described above, the following actions and effects can be achieved.
(1) Even when the number of three-dimensional object models registered in the three-dimensional object model database 42 increases, objects can be efficiently recognized and a high-speed system can be achieved because a three-dimensional object model exhibiting a high simultaneous recognition probability with the three-dimensional object model with which the object is recognized first is prioritized in the recognition attempts. Furthermore, even when the system speed is to be increased by stopping the object recognition processing in a predetermined number of attempts, a decrease in the recognition accuracy can be suppressed.
(2) When there are similar object models having similar shapes, among the three-dimensional object models registered in the three-dimensional object model database 42, or when there is an object model having a higher simultaneous recognition probability with another three-dimensional object model than that with a three-dimensional object model similar thereto and recognized at the same time, the recognition accuracy can be improved by rearranging the recognition order of the similar objects.

For example, given that an object model A and an object model B exhibit high false recognition rates in the object position/orientation estimations, and the object model A, an object model C, and an object model D are recognized simultaneously in a certain input image, if average simultaneous recognition probabilities PB of the object models B-C and the object models B-D are found to be higher than average simultaneous recognition probabilities PA of the object models A-C and the object models A-D, through comparisons of these average simultaneous recognition probabilities, the object model A having been recognized is replaced with the object model B, before the object position/orientation estimation processing is performed. In this manner, the recognition accuracy can be improved, compared with when a single object model is used in the recognition.

### Third Embodiment

A third embodiment of a behavior analysis system will now be described. In the following description, the same components as those in the first embodiment are given the same reference numerals, and differences will be mainly explained. The points not specifically described hereunder are the same as those in the first embodiment. The present embodiment is different from the first embodiment mainly in that the body model plotting unit 14 and the object model plotting unit 15 correct possible object positions and orientations using the body model and the object model data plotted in the virtual space.

In the body model plotting unit 14 and the object model plotting unit 15, if the body model and the object model plotted in the virtual space intersect with each other, an orientation of the object model is searched, among the other orientations resulting in a reduction in the amount of mesh intersection, for an orientation the vertices of which result in the smallest average distance with respect to the vertex of the object model at the initial orientation. If any orientation for avoiding the intersection of the meshes is found, the orientation is replaced with the initial orientation. As a result, the accuracy of the object position/orientation estimation can be improved.

For example, assuming an example for estimating the orientations of objects from an image including a long rod-shaped object and a hand on the front side of the rod-shaped object, if the region hidden behind the hand is the central part of the rod-shaped object, and both ends of the image are visible in the image, it is possible to estimate the position and the orientation of the object from the feature points at both ends, so that the effect given to the estimation accuracy by the hidden region is small. By contrast, if one side including one end of the rod-shaped object is the region hidden behind the hand, it is necessary to estimate the orientation from the shape of the visible other end, and therefore, the accuracy of the orientation is greatly affected by the angular error. In such a case, if a normally impossible setting (e.g., a setting in which an object model has gotten inside a body model) is plotted in the virtual space, the resultant interrelationship analysis becomes less accurate.

The orientation of the object model is therefore corrected in such a manner that the part of the object model having gotten inside the body model is eliminated. Specifically, a polygon traversed by a closed curve including the intersection of the body model and the object model is extracted, and every polygon continuous to the polygon is then extracted from the polygons inside the body model. Then, among the vertices constituting the extracted polygons, a vertex farthest away from the surface of the counterpart is searched. The coordinate point P at which a vertex V farthest away from the surface reaches the outside of the body model by the shortest distance is then calculated, and a new object position and orientation is calculated, with the vertex V and the coordinate point P at the matching position, by finding a new position and orientation of the object minimizing the distances of the other vertices with respect to their respective original positions.

According to the third embodiment described above, even when a major part of the object is hidden by another object or a body in the input image data, the accuracy of the object position/orientation estimations can be improved.

### Fourth Embodiment

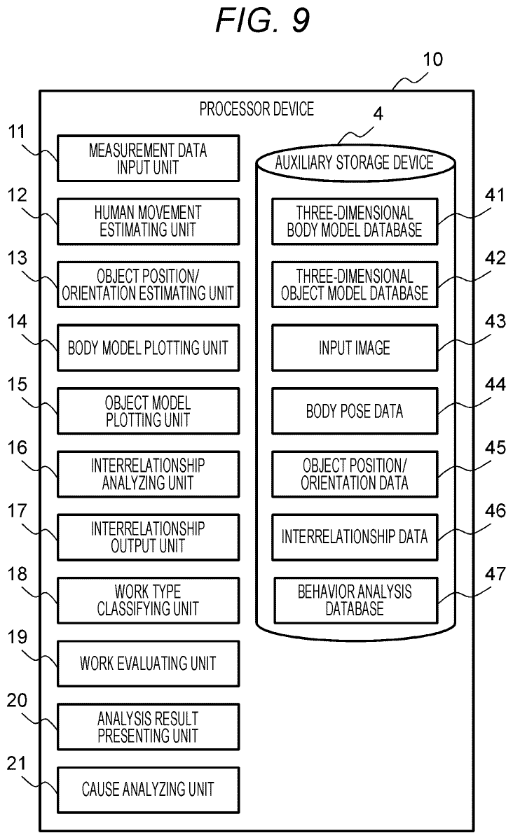

A fourth embodiment of a behavior analysis system will now be described with reference to FIG. 9. In the following description, the same components as those in the first embodiment are given the same reference numerals, and differences will be mainly explained. The points not specifically described hereunder are the same as those in the first embodiment. This embodiment is different from the first embodiment mainly in that the interrelationship data 46 generated from a plurality of pieces of input data is stored in a behavior analysis database 47 for each type of work.

FIG. 9 is a functional block diagram illustrating functions of the processor device 10 included in the behavior analysis system according to the fourth embodiment. Note that, in FIG. 9, data stored in the auxiliary storage device 4 included in the processor device 10 is also illustrated.

The processor device 10 according to this embodiment includes a work type classifying unit 18, a work evaluating unit 19, an analysis result presenting unit 20, a cause analyzing unit 21, and a behavior analysis database 47, in addition to the configuration of the first embodiment.

The work type classifying unit 18 adds a piece of work type information to the interrelationship data 46 received from the interrelationship output unit 17, using information input to the processor device 10 in one of the following methods.
A method in which a current work type is selected by a worker at the timing when the work type is switched, and is input to the measurement data input unit, along with the image data.
An approach in which a classification of work types is stored in the three-dimensional object model database 42 in advance, correspondingly to the registered object model IDs, and a work type is searched therefrom, on the basis of the list of the object model IDs corresponding to the object models recognized by the object position/orientation estimating unit 13.
An approach in which the work types is classified using an artificial-intelligence (AI) model having been trained with relationships between an input image and a work type.

The work evaluating unit 19 evaluates the work by comparing the interrelationship data 46 with data stored in the behavior analysis database 47, the data being classified under the same type of work. For example, the coordinates of a trajectory followed by the body during the work are compared with trajectory information TR (such as statistics of trajectory information, trajectory information selected as exemplary) of a body model performing the same work, the trajectory information being stored in the behavior analysis database 47, and a part where the trajectory coordinates are very different is evaluated as a deviation in the trajectory. As another example, when the type of the work is wiping for wiping the surface of an object, by extracting the region determined to be in contact from the trajectory information, it is possible to make the evaluations more efficiently.

The analysis result presenting unit 20 visually displays an analysis result by combining the body model plotted in the virtual space by the body model plotting unit 14 and the object model plotted in the virtual space by the object model plotting unit 15, and the data stored in the behavior analysis database 47. For example, when the type of the work is wiping for wiping the surface of an object, it is possible to notify the worker of the area where the work has completed, by displaying an image of the object model and the body model on a display via the input/output device 5 or the communication device 6, as an image from a certain viewpoint in the virtual space, using a different color for the surface area of the object model determined to be in contact with the body model. As another example, when the type of work is tightening of a screw into the object, it is possible to notify the worker of the progress of the work by causing the work evaluating unit 19 to analyze the amount by which the screw is rotated with respect to the object model orientation coordinates, on the basis of the body model trajectory information TR, and to output an image with the color of the screw model changed in accordance with the amount of rotation thus analyzed, to the display via the input/output device 5 or the communication device 6, as an image from a certain viewpoint in the virtual space.

The cause analyzing unit 21 provides a determination result on the quality of work to the behavior analysis database 47, and extracts interrelationship data 46 having a significant effect on the quality of work. For example, when the work type is maintenance or manufacturing of a device, the cause analyzing unit 21 provides a result of checking the operation of the device or the performance of the device after such work is performed, as the quality of work. The cause analyzing unit 21 extracts the interrelationship data 46 related to the quality of work on the basis of the correlation between the interrelationship data 46 of results of pieces of work stored in the behavior analysis database 47 and the quality of work, or on the scale of the deviation with respect to an average included in the interrelationship data, at the time when a fail is determined.

According to the fourth embodiment described above, the following actions and effects can be achieved.
(1) By storing the interrelationship data 46 for different types of input data in the behavior analysis database 47, and classifying the interrelationship data for each type of work, it is possible to obtain variance of the interrelationship data for each class, so that the significance of the behavior in the work can be evaluated.
(2) By enabling the work evaluating unit 19 to compare the behavior analysis database 47 with the interrelationship data 46 using a trajectory of a three-dimensional body model in the object model orientation coordinate system, it becomes possible to evaluate the behavior performed on a target object that is not fixed. Therefore, the information about the deviation of work can be provided to a trainee, enabling an efficient training information to be provided.
(3) By enabling the analysis result presenting unit 20 to visually present the analysis result of the interrelationship by combining the body model and the object model plotted in the virtual space and the data stored in the behavior analysis database 47, the body model and the object model being plotted by the body model plotting unit 14 and the object model plotting unit 15, respectively, information on the progress of the work can be provided to the worker.
(4) The cause analyzing unit 21 can extract the interrelationship data 46 related to a work quality, and provide specific work information useful for improving the quality of performance of the type of work.

In each embodiment described above, the configuration of the functional blocks is merely an example. Some functional configurations illustrated as separate functional blocks may be integrated, or a configuration illustrated as one functional block may be divided into two or more functional blocks. In addition, some of the functions of each functional block may be included in another functional block.

In the embodiments and modifications described above, a program may be stored in the ROM 2 or the auxiliary storage device 4. Furthermore, the processor device 10 may include an input/output interface (not illustrated), and a program may be read from another device via a medium that can be used by the input/output interface and the processor device 10, as required. Examples of the medium herein include a storage medium removable from the input/output interface, or a communication medium. The communication medium means a network such as a wired, wireless, or optical network, or a carrier wave or a digital signal propagating through the network.

Note that the present invention is not limited to the embodiments described above, and includes various modifications and configurations equivalent thereto, within the gist of the appended claims. For example, the embodiments have been described above in detail in order to describe the present invention in an easy-to-understand manner, and the present invention is not necessarily limited to those having all the described configurations. A part of the configuration according to one embodiment may be replaced with the configuration according to another embodiment. In addition, the configuration according to another embodiment may be added to the configuration according to one embodiment. In addition, another configuration may be added to, deleted from, and replaced with a part of the configuration according to each of the embodiments.

In addition, a part or all of the above-described configurations, functions, processing units, processing means, and the like may be implemented as hardware by, for example, designing using an integrated circuit, or may be implemented as software by a processor interpreting and executing a program for implementing each function.

Information such as a program, a table, and a file for implementing each of the functions may be stored in a recording device such as a memory, a hard disk, and a solid-state drive (SSD), or a recording medium such as an IC card, an SD card, and a digital versatile disk (DVD).

In addition, control lines and information lines presented are those considered to be necessary for the explanation, and are not necessarily the representations of all of the control lines and the information lines required in implementations. In reality, almost all of the configurations are considered to be connected to one another.

What is claimed is:

1. A behavior analysis system that analyzes an interrelationship between a worker and an object, the behavior analysis system comprising:
a computer including a processor device configured to execute predetermined processing and a storage device connected to the processor device, wherein
the processor device includes:
an input unit configured to receive an input of measurement data collected from the worker and the object;
a human movement estimating unit configured to estimate a movement of the worker based on the measurement data;
an object position/orientation estimating unit configured to estimate a position and an orientation of the object based on the measurement data;
an object model plotting unit configured to extract an object model having a same shape as the object having the position and the orientation estimated, from the object model database, and to plot the extracted object model in a virtual space at the position and the orientation estimated by the object position/orientation estimating unit;
a body model plotting unit configured to extract a body model of the worker having the movement estimated, from a body model database, and to plot the extracted body model in the virtual space in accordance with the movement estimated by the human movement estimating unit;
an interrelationship analyzing unit configured to analyze an interrelationship between the body model and the object model based on a position of the body model and the position and the orientation of the object model plotted in the virtual space; and
an interrelationship output unit configured to output the interrelationship analyzed by the interrelationship analyzing unit.

2. The behavior analysis system according to claim 1, wherein
the object model database records a simultaneous recognition probability between object models being stored, and
the object position/orientation estimating unit extracts object models having a high simultaneous recognition probability recorded in the object model database, at a higher priority.

3. The behavior analysis system according to claim 1, wherein the object model plotting unit plots the extracted object model in the virtual space by using a position of the body model plotted by the body model plotting unit.

4. The behavior analysis system according to claim 1, further comprising a behavior analysis database that stores the interrelationship analyzed by the interrelationship analyzing unit for each type of work.

5. The behavior analysis system according to claim 4, further comprising a work evaluating unit configured to make an evaluation of work by comparing an interrelationship stored in the behavior analysis database, the interrelationship being used as a criterion of an evaluation, with an interrelationship that is to be evaluated, resultant of an analysis performed by the interrelationship analyzing unit.

6. The behavior analysis system according to claim 4, further comprising an analysis result presenting unit configured to present the interrelationship analyzed by the interrelationship analyzing unit to the worker.

7. The behavior analysis system according to claim 4, further comprising a cause analyzing unit that records a result of determining quality of work in the behavior analysis database, and extracts an interrelationship having a significant effect on the quality of work.

8. The behavior analysis system according to claim 1, wherein the interrelationship analyzing unit is configured to:
calculate a correlation coefficient between coordinates of the body model and coordinates of the object model;
compare an acceleration of the body model with an acceleration of an object model held by the body model;
determine a contact between the body model and the object model;
calculate a rotation amount or an angular velocity of the body model and a rotation amount or an angular velocity of the object model;
determine a shape of the object model when the object model and the body model come into contact with each other;
calculate a contact surface area of the body model using the object model;
analyze at least one of a positional relationship between a direction of an index finger of the body model and the object model, and a determination of a shape of a hand of the body model, as the interrelationship.

9. A behavior analysis method by which a behavior analysis system analyzes an interrelationship between a worker and an object, wherein
the behavior analysis system comprises a computer including a processor device configured to execute predetermined processing and a storage device connected to the processor device, and
the behavior analysis method comprises:
receiving at which the processor device receives an input of measurement data collected from the worker and the object;
first estimating at which the processor device estimates a movement of the worker based on the measurement data;
second estimating at which the processor device estimates a position and an orientation of the object based on the measurement data;
extracting at which the processor device extracts an object model having a same shape as the object having the position and the orientation estimated, from the object model database, and plots the extracted object model in a virtual space at the position and the orientation having been estimated;
extracting at which the processor device extracts a body model of the worker having the movement estimated, from a body model database, and plots the extracted body model in the virtual space in accordance with the movement estimated at the first estimating;
analyzing at which the processor device analyzes an interrelationship between the body model and the object model based on the position of the body model and the position of the object model plotted in the virtual space; and
outputting at which the processor device outputs the interrelationship analyzed at the analyzing.
